(19) United States
(12) Patent Application Publication
(10) Pub. No.: US 2011/0126594 A1
(43) Pub. Date: Jun. 2, 2011

(54) APPARATUS FOR PRODUCING MOLTEN GLASS, APPARATUS AND PROCESS FOR PRODUCING GLASS PRODUCTS

(75) Inventors: Hiroshi Matsui, Nagoya-shi (JP); Tatsuya Okamoto, Nagoya-shi (JP); Shingo Yamada, Nagoya-shi (JP)

(73) Assignee: ASAHI GLASS COMPANY, LIMITED, Chiyoda-ku (JP)

(21) Appl. No.: 12/628,643

(22) Filed: Dec. 1, 2009

(51) Int. Cl. C03B 5/26

(52) U.S. Cl. 65/126; 65/324

(57) ABSTRACT

The present invention provides an apparatus for producing molten glass, an apparatus for producing glass products and a process for producing glass products, which achieve production of various types of glass products of small lot with high energy efficiency in a short time.

An apparatus for producing molten glass comprising an upper mechanism having at least one upper furnace body constituting an upper part of a glass-melting furnace, and at least one lower furnace body constituting a lower part or a glass-melting furnace and configured to be coupled with the upper furnace body to constitute at least one glass-melting furnace;
one or both of the upper mechanism and the lower mechanism being configured so that their positions are movable so that at least one glass-melting furnace is constituted by combining the upper furnace body and the lower furnace body and the combination of the upper furnace bodies and the lower furnace bodies is changeable;
the upper furnace body having an oxygen burner for producing a downward flame in the glass-melting furnace constituted by the upper furnace body and the lower furnace body, a gas-supplying line for supplying a combustion-support gas and a fuel gas to the oxygen burner, and a glass-raw-material-conveying path for supplying a glass raw material to the flame produced by the oxygen burner; and
the lower mechanism having a furnace-bottom portion of the lower furnace body for storing a molten glass, a temperature-adjusting bath connected with the furnace-bottom portion and for storing the molten glass flown from the furnace-bottom portion and conducting a temperature adjustment, and a molten-glass-discharge port for discharging the molten glass from the temperature-adjusting bath.

### BACKGROUND OF THE INVENTION

1. Field of the Invention

The present invention relates to an apparatus for producing molten glass, and an apparatus and a process for producing glass products. More specifically, the present invention relates to an apparatus for producing molten glass and an apparatus and a process for producing glass products, which can produce so-called various glass products of small lot, with high energy efficiency in a short time.

2. Discussion of Background

Heretofore, as an apparatus for producing glass products, an apparatus has been used, which has a glass-melting furnace, a temperature-adjusting bath connected with the glass-melting furnace, and a forming apparatus connected with a discharge port of the temperature-adjusting bath, via e.g. a cutter as the case requires. As the glass-melting furnace in such an apparatus for producing glass products, a furnace has been employed, which has a remarkably large length wherein a melting zone is formed in an upstream portion of the furnace and a refining zone (degassing zone) is formed in a middle portion to a downstream portion of the furnace. Such a glass-melting furnace is configured so that a glass raw material is input from the most upstream portion of the furnace, and melted by using a burner attached to a side wall of the glass-melting furnace (refer to e.g. Patent Documents 1 to 3).

However, such a conventional apparatus for producing glass products having the above glass-melting furnace, is configured to melt e.g. a glass raw material input into the furnace of the glass-melting furnace, by using an in-furnace radiation from combustion produced by a burner. Accordingly, there are problems that (1) the energy efficiency is low even in a case of combustion using an oxygen burner as the burner, (2) the e.g. glass raw material input into the furnace contains materials having different melting points, and materials having low melting points are melted soon but materials having high melting points are melted late, whereby homogenous melting of the entire material is difficult to achieve and it takes a long time to melt them homogenously, and (3) since there is un-molten glass raw material having a low temperature in the upper portion of the molten glass produced in the glass-melting furnace, gas generated in the molten glass is not easily removable and it takes a long time for degassing. Further, due to these problems, the glass-melting furnace needs to be very long in the size, and exchange of the molten glass in the furnace becomes troublesome, and accordingly, there is a problem that (4) such an apparatus is extremely unsuitable for production of various glass products of small lot.

Patent Document 1: JP-A-11-11953

Patent Document 2: JP-A-11-11954

Patent Document 3: JP-A-2005-15299

### SUMMARY OF THE INVENTION

The problems to be solved by the invention is to provide an apparatus for producing molten glass, and an apparatus and a process for producing glass products, which can produce so-called various glass products of small lot, with high energy efficiency in a short time.

In order to solve the above problems, the present invention provides an apparatus for producing molten glass comprising an upper mechanism having at least one upper furnace body constituting an upper part of a glass-melting furnace, and a lower mechanism having at least one lower furnace body constituting a lower part of a glass-melting furnace and configured to be coupled with the upper furnace body to constitute at least one glass-melting furnace; one or both of the upper mechanism and the lower mechanism being configured so that their positions are movable so that at least one glass-melting furnace is constituted by combining the upper furnace body and the lower furnace body and the combination of the upper furnace body and the lower furnace body is changeable; the upper furnace body having an oxygen burner for producing a downward flame in the glass-melting furnace constituted by the upper furnace body and the lower furnace body, a gas-supplying line for supplying a combustion-support gas and a fuel gas to the oxygen burner, and a glass-raw-material-conveying line for supplying a glass raw material to the flame produced by the oxygen burner; and the lower mechanism having a furnace-bottom portion of the lower furnace body for storing a molten glass, a temperature-adjusting bath connected with the furnace-bottom portion and for storing the molten glass flown from the furnace-bottom portion and conducting a temperature adjustment, and a molten-glass-discharge port for discharging the molten glass from the temperature-adjusting bath.

The apparatus for producing molten glass according to the present invention comprises an upper mechanism and a lower mechanism. The upper mechanism has at least one upper furnace body constituting an upper part of a glass-melting furnace. The lower mechanism has a lower furnace body constituting a lower part of a glass-melting furnace and configured to be coupled with the upper furnace body to constitute a glass-melting furnace; a temperature-adjusting bath connected with the lower furnace body; and a forming apparatus connected to a discharge port of the temperature-adjusting bath. The upper mechanism and lower mechanism are configured so that one is movable relatively to the other or both of them are independently movable. A means for moving the mechanism(s) may be a known means such as a moving truck adapted to support the upper mechanism and/or the lower mechanism and self-moving on a rail, or a crane adapted to suspend the mechanism(s) and movable on a rail.

In the apparatus for producing molten glass according to the present invention, the constructions of the temperature-adjusting bath and the forming apparatus of the lower mechanism are the same as those of conventional apparatuses for producing glass products except that the temperature-adjusting bath and the forming apparatus are movable as a group. For this reason, hereinafter, explanation will be mainly made to the glass-melting furnace constituted by the upper furnace body and the lower furnace body. An oxygen burner is attached to a ceiling wall of the upper furnace body constituting an upper part of the glass-melting furnace in the upper mechanism, so that the oxygen burner points downwardly.

To the oxygen burner of the upper furnace body, a combustion-supporting gas and a fuel gas are supplied, and a glass-raw material is supplied by a carrier gas, whereby when the oxygen burner produces a downward combustion, the glass-raw material is supplied downwardly into the flame and melted. As such an oxygen burner, a known oxygen burner such as one described in JP-A-8-312938, JP-A-2000-55340 or JP-A-2000-103656 may be employed. These oxygen burners each has a leading edge portion having a nozzle structure constituted by concentrically arranged plurality of supply nozzles such as a fuel-supplying nozzle, a primary combustion-supporting-gas-supplying nozzle, a process-product (glass raw material)-supplying nozzle and a secondary combustion-supporting-gas-supplying nozzle in this order from the center towards the outer periphery.

The upper mechanism and/or the lower mechanism is moved, and at least one upper furnace body of the upper mechanism is coupled with at least one lower furnace body of the lower mechanism to constitute a glass-melting furnace, and in this state, the oxygen burner in the upper furnace body produces a downward combustion and a glass raw material is downwardly supplied into the flame so as to be melted to produce a molten glass. The molten glass is temporarily stored in a furnace-bottom portion of the lower furnace body, and the molten glass flows into a temperature-adjusting bath connected with the lower furnace body via e.g. a throat.

As described above, when the oxygen burner is attached so as to point downwardly from the ceiling wall of the upper furnace body constituting an upper part of the glass-melting furnace, and the combustion-supporting gas and the fuel gas are supplied to the burner to produce a downward combustion, not only the temperature of the flame itself becomes high, but also the flame heats a surface of molten glass temporarily stored in the furnace-bottom portion of the lower furnace body just under the flame. When the glass raw material is supplied downwardly into the flame, the glass raw material is melted in an extremely short time in a high-temperature atmosphere in the flame or the vicinity of the flame. Moreover, at this time, moisture in the glass raw material supplied downwardly into the high-temperature flame burning downwardly, is evaporated instantly, and a material in a form of carbonic compound is decomposed to discharge a gas, whereby gas-generation amount in the molten glass in the furnace-bottom portion is significantly reduced. Moreover, since such a molten glass is stored in the furnace-bottom portion even though just temporarily and homogenization and degassing of the molten glass is promoted, it is possible to directly send the molten glass to the temperature-adjusting bath without passing it through a refining zone (degassing zone) as in conventional glass-melting furnaces, without causing any problem in the quality of the molten glass as the raw material for glass products. By selecting the most suitable upper furnace body and selecting a group including the lower furnace body, the temperature-adjusting bath and the forming apparatus, according to the desired size or shape of the glass bottle, and coupling the upper furnace body with the lower furnace body to constitute the above-mentioned glass-melting furnace, it is possible to produce various glass products of small lot with high energy efficiency in a short time.

In the apparatus for producing molten glass according to the present invention, in terms of the construction of the entire apparatus, it is preferred that the upper mechanism has one upper furnace body that is provided so that its position is movable, and the lower mechanism has at least two groups each including the lower furnace body and the temperature-adjusting bath that are provided so as to be stationary. As an alternative, it is preferred that the upper mechanism has one upper furnace body that is provided so as to be stationary, and the lower mechanism has at least two groups each including the lower furnace body and the temperature-adjusting bath that are provided so that their positions are movable. In both of these constructions, movement of the upper mechanism or the lower mechanism may be linear or circular.

Further, it is preferred that the upper mechanism has an elevating means of the oxygen burner, so that the distance between the leading edge portion of the oxygen burner and the surface of the molten glass temporarily stored in the lower furnace body is adjustable by operation of the elevating means. By adjusting the distance between the leading edge portion of the burner and the surface of the molten glass in addition to adjusting the combustion intensity of the oxygen burner, it is possible to more flexibly control heating of the molten glass particularly its surface. When the combustion intensity of the oxygen burner is adjusted, the flame length tends to change and the distance between the leading edge portion of the flame and the surface of the molten glass tends to change, and if the distance is not desirable, the distance can be adjusted more suitably by the above elevating means.

Further, it is preferred that the furnace-bottom portion of the lower furnace body has a partition wall for storing the molten glass, and is configured so that the molten glass overflows the partition wall and flows into the temperature-adjusting bath. By temporarily storing the produced molten glass in such a small pool, it is possible to further promote homogenization and degassing of the molten glass.

Further, the present invention provides an apparatus for producing glass products, which comprises the apparatus for producing molten glass as defined above and an apparatus for forming molten glass that is connected to the molten-glass-discharge port of the apparatus for producing molten glass.

Further, the present invention provides a process for producing glass products, which uses the apparatus for producing molten glass as defined above, and comprises melting a glass raw material in a flame of oxygen burner in the glass-melting furnace constituted by the upper furnace body and the lower furnace body to produce a molten glass, storing the molten glass in the furnace-bottom portion of the lower furnace body, and feeding the molten glass stored in the furnace-bottom portion through the temperature-adjusting bath to a forming apparatus, to produce glass products.

Furthermore, the present invention provides a process for producing glass products, which uses the above apparatus for producing glass products as defined above, and comprises melting a glass raw material in a flame of oxygen burner in the glass-melting furnace constituted by the upper furnace body and the lower furnace body to produce a molten glass, storing the molten glass in the furnace-bottom portion of the lower furnace body, and feeding the molten glass stored in the furnace-bottom portion through the temperature-adjusting bath to a forming apparatus, to produce glass products.

The apparatus for producing molten glass and the apparatus and the process for producing glass products of the present invention provide an effect of producing various glass products of small lot with high energy efficiency in a short time.

### BRIEF EXPLANATION OF THE DRAWINGS

FIG. 1 is a general plan view schematically showing, with partial omission, an apparatus for producing glass bottles as an example of the apparatus for producing glass products according to the present invention.

FIG. 2 is a partial side view schematically showing the apparatus for producing glass bottles of FIG. 1, wherein a part of the apparatus is shown in a vertical cross-section with enlargement.

FIG. 3 is a general plan view schematically showing, with partial omission, another apparatus for producing glass bottles as an example of the apparatus for producing glass products according to the present invention.

FIG. 4 is a general plan view schematically showing, with partial omission, still another apparatus for producing glass bottles as an example of the apparatus for producing glass products according to the present invention.

FIG. 5 is a partial side view schematically showing still another apparatus for producing glass bottles as an example of the apparatus for producing glass products according to the present invention, wherein a part of the apparatus is shown in a vertical cross-section with enlargement.

### EXPLANATION OF NUMERALS

11, 11a, 11b, 11c: Upper mechanism
21, 21a, 21b, 21c: Upper furnace body
22, 22c: Oxygen burner
31, 32, 31a, 32a, 31b, 32b, 31c, 32c: Rail
33, 33a, 33c: Truck
23, 34, 35, 23c, 34c, 35c: Cylinder mechanism
41: Glass-raw-material-conveying line
43: Glass-raw-material-supplying line
51, 51a, 51b, 51c: Lower mechanism
61 to 64, 61a to 64a, 61b to 66b, 63c: Lower furnace body
71 to 74, 71a to 74a, 71b to 76b, 73c: Temperature-adjusting bath
91 to 94, 91a to 94a, 91b to 96b: Forming apparatus
100, 100c: Discharge port
120: Partition wall
130: Gas-supplying line
150, 150c: Furnace-bottom portion

### EXAMPLES

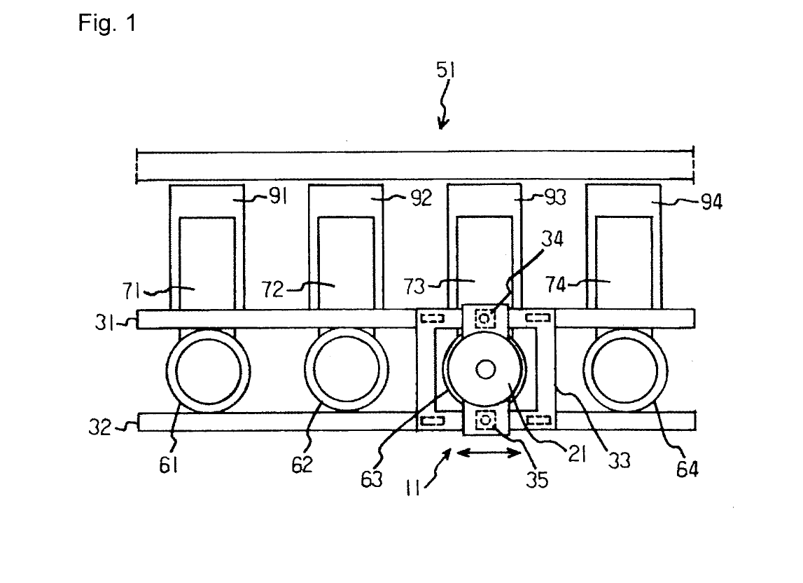

FIG. 1 is a general plan view schematically showing an apparatus for producing glass bottles as an example of the apparatus for producing glass products according to the present invention including an apparatus for producing molten glass. The apparatus for producing glass bottles schematically shown in FIG. 1 is constituted by an upper mechanism 11 and a lower mechanism 51. The upper mechanism 11 has one upper furnace body 21 that is an upper part of a glass-melting furnace. The lower mechanism 51 has four groups each including a lower furnace body 61 to 64 that is a lower part of the glass-melting furnace and configured to be coupled with the upper furnace body 21 to constitute the glass-melting furnace; a temperature-adjusting bath 71 to 74 connected with the lower furnace body 61 to 64 via a throat, a cutter 81 to 84 (not shown in FIG. 1, hereinafter the same) connected with a discharge port 100 (not shown in FIG. 1, hereinafter the same) of the temperature-adjusting bath 71 to 74, and a forming apparatus 91 to 94 connected with the cutter 81 to 84 via an input shoot.

The upper furnace body 21 constituting the upper mechanism 11 is adapted to be supported by a truck 33 self-movable on two parallel rails 31 and 32, via cylinder mechanisms 34 and 35, so that the upper furnace body 21 moves linearly along the two rails 31 and 32 in a state that it is lifted by the cylinder mechanisms 34 and 35. Meanwhile, the above groups constituting the lower mechanism 51 are arranged at equal intervals in the transverse direction, and the lower furnace bodies 61 to 64 of respective groups are disposed at positions to which the upper furnace body 21 linearly moving along the two rails 31 and 32 faces downwardly. FIG. 1 shows a state that the upper furnace body 21 at a position facing downwardly to the lower furnace body 63, is lowered by operation of the cylinder mechanisms 34 and 35, so that the upper furnace body is coupled with the lower furnace body 63 to constitute a glass-melting furnace. In the case of FIG. 1, the upper mechanism 11 having one upper furnace body 21 is provided so as to be movable, and the lower mechanism 51 having four groups in total each including the lower furnace body 61 to 64, the temperature-adjusting bath 71 to 74, the cutter 81 to 84 and the forming device 91 to 94, is provided stationary.

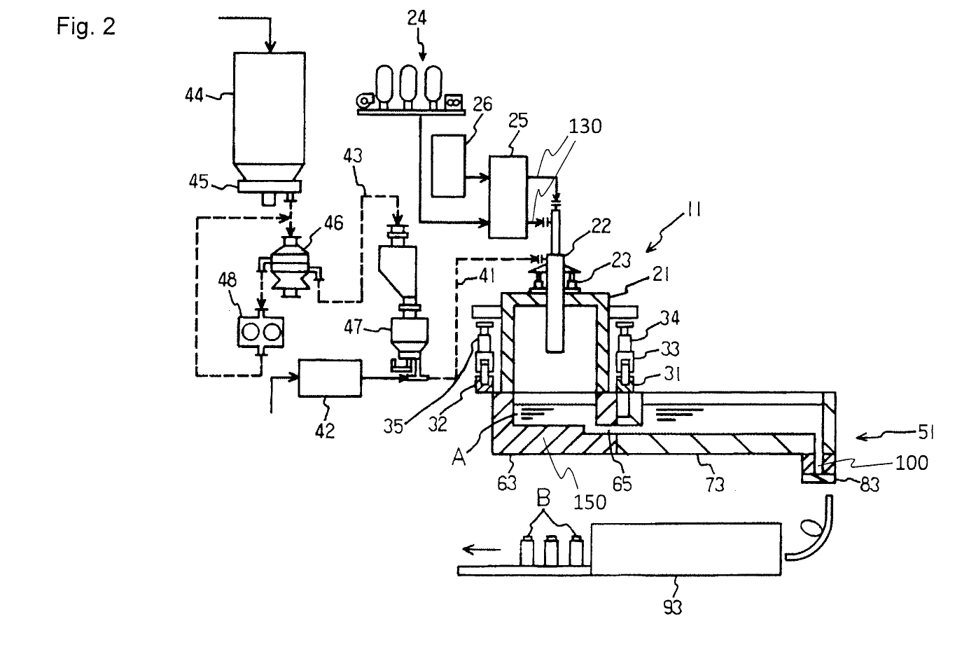

FIG. 2 is a partial side view schematically showing the apparatus for producing glass bottles of FIG. 1, wherein a part of the apparatus is shown in a vertical cross-section with enlargement. As described above, by lowering the upper furnace body 21 and coupling it with the lower furnace body 63, the glass-melting furnace is constituted, and in the downstream side of the lower furnace body 63 thus constituting the glass-melting furnace, a temperature-adjusting bath 73 is connected via a throat 65. Further, to the discharge port 100 of the temperature-adjusting bath 73, a cutter 83 is connected, and on the downstream side of the cutter 83, a forming apparatus 93 is connected via an input shoot. The construction of the apparatus other than the glass-melting furnace is approximately the same as those of conventional apparatuses for producing glass bottles. The glass-melting furnace schematically shown in FIGS. 1 and 2 has a substantially square transverse cross-section and has a slightly vertically elongated rectangular external appearance as a whole. To a ceiling wall of the upper furnace body 21 constituting an upper part of the glass-melting furnace, an oxygen burner 22 is attached so as to point downwardly, and a bottom portion 150 of the lower furnace body 63 just below the oxygen burner 22 is configured to temporarily store molten glass A. The oxygen burner 22 is attached to the ceiling wall of the upper furnace body 21 via a cylinder mechanism 23, so as to be movable up and down so that the distance between the leading edge of the burner and the surface of the molten glass A is adjustable.

The oxygen burner 22 is constituted by a plurality of supply nozzles arranged concentrically as described above. The oxygen burner 22 is configured to be supplied with a combustion-supporting gas having an oxygen concentration of at least 90 vol % from an adsorption type oxygen generator 24 via a combustion control unit 25. Further, a fuel gas is supplied from a fuel tank 26 via the combustion control unit 25. The combustion-supporting gas and the fuel gas are supplied to the oxygen burner 22 through a gas-supplying line 130. Further, to the oxygen burner 22, a glass-raw-material-conveying line 41 is connected so as to supply e.g. a powder-form glass raw material by a carrier gas. The means for conveying the glass raw material is not limited to the carrier gas, but it may be a mechanical means. On the upstream side of the glass-raw-material-conveying line 41, a compressor 42 with a dryer is connected, and a glass-raw-material-supplying line 43 is connected therebetween via a predetermined-amount-supplying apparatus 47. On the upstream side of the glass-raw-material-supplying line 43, there are provided a hopper 44 for storing glass raw material, a predetermined-amount-cutting apparatus 45 connected with the hopper 44, and a vibration comb 46 connected with the predetermined-amount-cutting apparatus 45. Further, the predetermined-amount-supplying apparatus 47 is connected with the vibration comb 46. Further, on the upstream side of the glass-raw-material-supplying line 43, a pulverizer 48 is provided for pulverizing a coarse material combed by the vibration comb 46 and returning it to the upstream side of the vibration comb 46. The glass raw material is supplied through the hopper 44, the predetermined-amount-cutting apparatus 45, the vibration comb 46, the predetermined-amount-supplying apparatus 47, and through the pulverizer 48 as the case requires, to reach the glass-raw-material-supplying line 43, whereby a predetermined amount of the powder-form glass raw material is further supplied through the glass-raw-material-conveying line 41 to reach the oxygen burner 22. In the case of FIG. 2, the fuel gas and the combustion-supporting gas having an oxygen concentration of at least 90 vol % are supplied to the oxygen burner 22 pointing downwardly from the ceiling wall of the upper furnace body 21 constituting an upper part of the glass-melting furnace, to produce a combustion, and in the flame, e.g. the glass material of power form is supplied downwardly so that the raw material is melted.

In the case of FIG. 2, as described above, the apparatus is configured so that e.g. the glass raw material is melted by the oxygen burner 22 of the upper furnace body 21 constituting an upper part of the glass-melting furnace, to produce a molten glass A, and the molten glass A is temporarily stored in a furnace bottom portion 150 of the lower furnace body 63 constituting a lower part of the glass-melting furnace, homogenization and degassing is carried out here, and the molten glass A flows into the temperature-adjusting bath 73 through the throat 65. Then, the molten glass whose temperature has been adjusted in the temperature-adjusting bath 73 is discharged from the discharge port 100 and is cut into the amount of a single glass bottle by the cutter 83. Further, the cut piece is supplied to the forming apparatus 93 through an input shoot, and subjected to blow-forming to produce a glass bottle B.

The composition of the powder-form glass raw material stored in the hopper 44 is changed according to the desired physical property of the glass bottle, and a group including e.g. an appropriate forming apparatus, is selected from the groups in the lower mechanism 51 according to the desired size or shape of the glass bottle. For example, when the leftmost group is selected in FIG. 1, the upper furnace body 21 is moved onto the lower furnace body 61 of the group, they are coupled to constitute a glass-melting furnace, and a glass bottle is produced as described above.

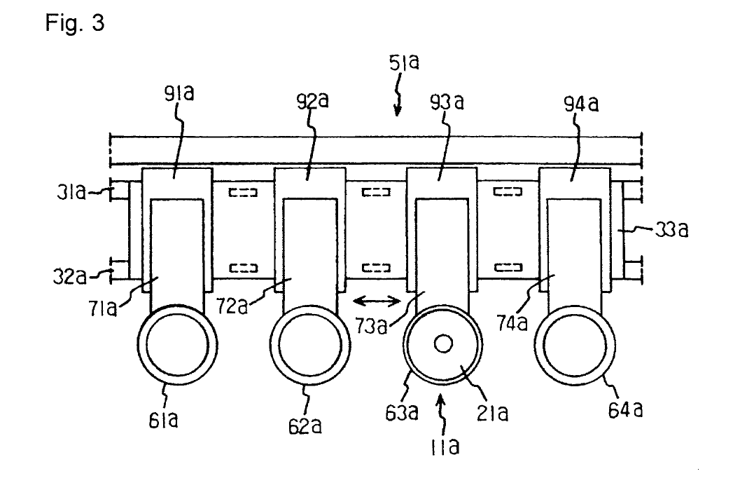

FIG. 3 is a general plan view schematically showing, with partial omission, another apparatus for producing glass bottles as an example of the apparatus for producing glass products according to the present invention. For convenience of explanation, constituents in common with those of FIG. 1 are designated by the same reference numerals as those of FIG. 1 followed by “a”. The apparatus for producing glass bottles schematically shown in FIG. 3 is also constituted by an upper mechanism 11a and a lower mechanism 51a. The upper mechanism 11a has an upper furnace body 21a that is an upper part of a glass-melting furnace. The lower mechanism 51a has four groups in total each including a lower furnace body 61a to 64a that is a lower part of the glass-melting furnace and configured to be coupled with the upper furnace body 21a to constitute the glass-melting furnace, a temperature-adjusting bath 71a to 74a connected with the lower furnace body 61a to 64a via a throat, a cutter 81a to 84a (not shown in FIG. 3, hereinafter the same) to be connected with a discharge port 100 (not shown, hereinafter the same) of the temperature-adjusting bath 71a to 74a, and a forming apparatus 91a to 94a connected with the cutter 81a to 84a via an input shoot.

The upper furnace body 21a constituting the upper mechanism 11a does not move in the horizontal direction, but it is movable up and down by a cylinder mechanism, not shown. Meanwhile, the groups constituting the lower mechanism 51a are mounted at equal intervals along a transverse direction on a truck 33a, and the truck 33a is configured to be movable linearly along two parallel rails 31a and 32a. In the case of FIG. 3, the upper furnace body 21a at a position where the upper furnace body 21a faces downwardly to the lower furnace body 63a, is lowered by operation of a cylinder mechanism, not shown, to be coupled with the lower furnace body 63a to thereby constitute a glass-melting furnace. In the case of FIG. 3, the upper mechanism 11a having one upper furnace body 21a is provided stationary except for up-down direction, and the lower mechanism 51 having four groups each including the lower furnace body 61a to 64a, the temperature-adjusting bath 71a to 74a, the cutter 81a to 84a and the forming apparatus 91a to 94a, is provided so as to be movable. Other portions in FIG. 3 are the same as those of FIGS. 1 and 2, and their explanations are omitted.

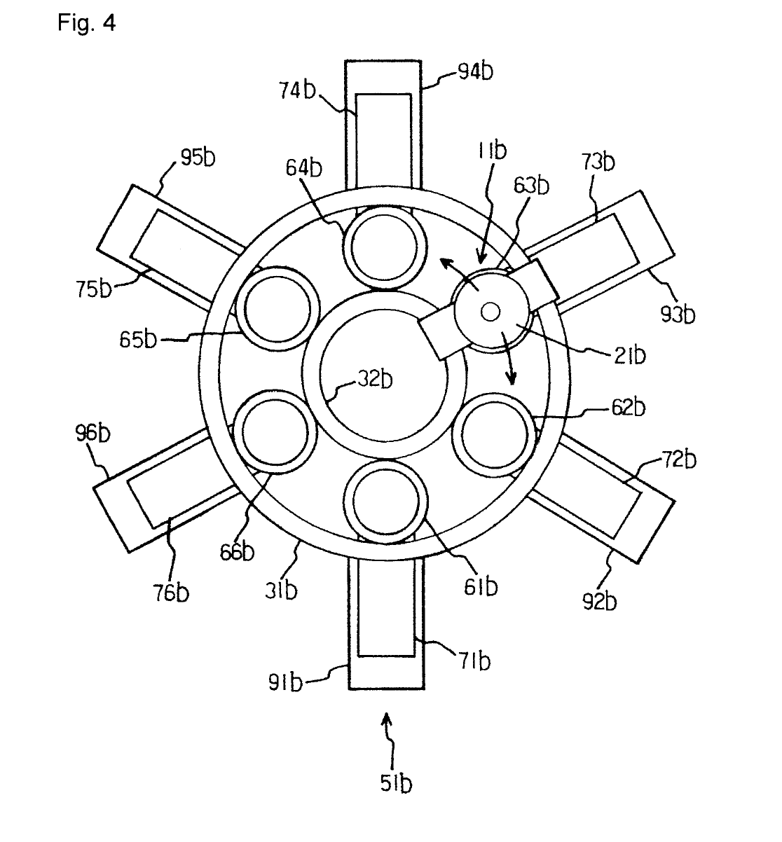

FIG. 4 is a general plan view schematically showing, with partial omission, still another apparatus for producing glass bottles as an example of the apparatus of producing glass products according to the present invention. For convenience of explanation, constituents in common with those of FIG. 1 are designated by the same reference numerals as those of FIG. 1 followed by “b”. The apparatus for producing glass bottles schematically shown in FIG. 4 is constituted by an upper mechanism 11b and a lower mechanism 51b. The upper mechanism 11b has one upper furnace body 21b that is an upper part of a glass-melting furnace. The lower mechanism 51b has six groups in total each including a lower furnace body 61b to 66b that is a lower part of the glass-melting furnace and configured to be coupled with the upper furnace body 21b to constitute the glass-melting furnace, a temperature-adjusting bath 71b to 76b connected with the lower furnace body 61b to 66b via a throat, a cutter 81b to 86b (not shown in FIG. 4, hereinafter the same) connected with a discharge port 100 (not shown in FIG. 4, hereinafter the same) of the temperature-adjusting bath 71b to 76b, and a forming apparatus 91b to 96b connected with the cutter 81b to 86b via an input shoot.

The upper furnace body 21b constituting the upper mechanism 11b is supported on a truck, not shown, self-movable on two ring-shaped rails 31b and 32b, via a cylinder mechanism, so that the upper furnace body 21b is movable circularly along the two rails 31b and 32b in a state that it is lifted by the cylinder mechanism. Meanwhile, the above groups constituting the lower mechanism 51b are arranged radially at equal intervals and the lower furnace bodies 61b to 66b of respective groups are disposed at positions to which the upper furnace body 21 moving circularly along the two rails 31b and 32b faces downwardly. FIG. 4 shows a state that the upper furnace body 21b at a position where it faces downwardly to the lower furnace body 63b, is lowered by operation of a cylinder mechanism, not shown, to be coupled with the lower furnace body 63b, so as to constitute the glass-melting furnace. In the case of FIG. 4, the upper mechanism 11b having one upper furnace body 21b is provided so as to be movable, and the lower mechanism 51b having six groups in total each including the lower furnace body 61b to 66b, the temperature-adjusting bath 71b to 76b, the cutter 81b to 86b and the forming apparatus 91b to 96b, is provided stationary. Also in the case of FIG. 4, the constructions of other portions are the same as those of FIGS. 1 and 2, and explanation of these portions are omitted.

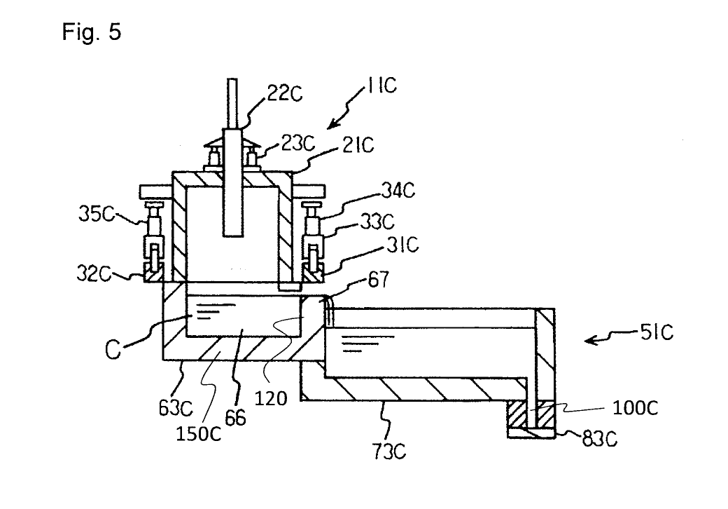

FIG. 5 is a partial side view schematically showing still another apparatus for producing glass bottles as an example of the apparatus for producing glass products according to the present invention, wherein a part of the apparatus is shown in a vertical cross-section with enlargement. The constructions of other portions whose illustration and explanation are omitted in FIG. 5, are the same as those of the apparatus for producing glass bottles of FIGS. 1 and 2. FIG. 5 corresponds to FIG. 2. Here, for convenience of explanation, constituents in common with FIG. 2 are designated by the same reference numerals as those of FIG. 2 followed by “c”. The apparatus for producing glass bottles of FIG. 5 is configured in the same manner as the apparatus for producing glass bottles of FIG. 2, so that an upper furnace body 21c of an upper mechanism 11c is lowered to be coupled with a lower furnace body 63c of a lower mechanism 51c to constitute a glass-melting furnace. Further, on the downstream side of the lower furnace body 63c constituting a lower part of the glass-melting furnace, a temperature-adjusting bath 73c is connected, and a cutter 83c is connected to a discharge port 100c of the temperature-adjusting bath 73c. Further, on the downstream side of the cutter 83c, a forming apparatus is connected via an input shoot, that are not shown. An oxygen burner 22c is attached to a ceiling wall of the upper furnace body 21c, so as to point downwardly, and a small pool 66 is formed on a bottom portion of the lower furnace body 63c to which the oxygen burner 22c faces downwardly, so that a molten glass C generated in the small pool 66 is temporarily stored. In order to store the molten glass C, a partition wall 120 for storing the molten glass is provided so that the molten glass flows over the partition wall and flows into the temperature-adjusting bath. The oxygen burner 22c is attached to the ceiling wall of the upper furnace body 21c via a cylinder mechanism 23c, so as to be movable up and down, whereby the distance between its leading edge and the surface of the molten glass C in the small pool 66 is adjustable. In the case of FIG. 5, a glass raw material is melted by the oxygen burner 22c of the upper furnace body 21c constituting an upper part of the glass-melting furnace, to produce a molten glass C, and the molten C is temporarily stored in the small pool 66 in the furnace-bottom portion 150c of the lower furnace body 63c constituting a lower part of the glass-melting furnace. The molten glass is further homogenized and degassed here, and the molten glass flows over a weir 67 forming the small pool 66 to flow into the temperature-adjusting bath 73c. Then, the molten glass whose temperature has been adjusted in the temperature-adjusting bath 73c is discharged through a discharge port 100c and cut into the amount of a single glass bottle by the cutter 83c, and the cut glass is put into the forming apparatus via an input shoot, that are not shown, to be blow-molded to produce a glass bottle.

In the above description of Examples, explanation was made to the process and the apparatus for producing glass bottles, but the present invention can be applied to other glass products such as plate glasses or frit glasses. For these glass products, the forming apparatus or the forming method are different from those for glass bottles, but the differences are within the range of known techniques used in apparatuses or processes for producing conventional plate glasses, frit glasses etc. Accordingly, explanations of these differences are omitted.

The entire disclosure of Japanese Application No. 2007-140131 filed on May 28, 2007 including specification, claims, drawings and summary are incorporated herein by reference in its entirety.

What is claimed is:

1. An apparatus for producing molten glass comprising an upper mechanism having at least one upper furnace body constituting an upper part of a glass-melting furnace, and a lower mechanism having at least one lower furnace body constituting a lower part of a glass-melting furnace and configured to be coupled with the upper furnace body to constitute at least one glass-melting furnace;
one or both of the upper mechanism and the lower mechanism being configured so that their positions are movable so that at least one glass-melting furnace is constituted by combining the upper furnace body and the lower furnace body and the combination of the upper furnace body and the lower furnace body is changeable;
the upper furnace body having an oxygen burner for producing a downward flame in the glass-melting furnace constituted by the upper furnace body and the lower furnace body, a gas-supplying line for supplying a combustion-support gas and a fuel gas to the oxygen burner, and a glass-raw-material-conveying line for supplying a glass raw material to the flame produced by the oxygen burner; and
the lower mechanism having a furnace-bottom portion of the lower furnace body for storing a molten glass, a temperature-adjusting bath connected with the furnace-bottom portion and for storing the molten glass flown from the furnace-bottom portion and conducting a temperature adjustment, and a molten-glass-discharge port for discharging the molten glass from the temperature-adjusting bath.

2. The apparatus for producing molten glass according to claim 1, wherein the upper mechanism has one upper furnace body that is provided so that its position is movable, and the lower mechanism has at least two groups each including the lower furnace body and the temperature-adjusting bath that are provided so as to be stationary.

3. The apparatus for producing molten glass according to claim 1, wherein the upper mechanism has one upper furnace body that is provided so as to be stationary, and the lower mechanism has at least two groups each including the lower furnace body and the temperature-adjusting bath that are provided so that their positions are movable.

4. The apparatus for producing molten glass according to claim 1, wherein the upper mechanism has an elevating means of the oxygen burner, so that the distance between the leading edge portion of the oxygen burner and the surface of the molten glass temporarily stored in the lower furnace body is adjustable by operation of the elevating means.

5. The apparatus for producing molten glass according to claim 1, wherein the furnace-bottom portion of the lower furnace body has a partition wall for storing the molten glass, and is configured so that the molten glass overflows the partition wall and flows into the temperature-adjusting bath.

6. An apparatus for producing glass products, which comprises the apparatus for producing molten glass as defined in claim 1 and an apparatus for forming molten glass that is connected to the molten-glass-discharge port of the apparatus for producing molten glass.

7. A process for producing glass products, which uses the apparatus for producing molten glass as defined in claim 1, and comprises melting a glass raw material in a flame of oxygen burner in the glass-melting furnace constituted by the upper furnace body and the lower furnace body to produce a molten glass, storing the molten glass in the furnace-bottom portion of the lower furnace body, and feeding the molten glass stored in the furnace-bottom portion through the temperature-adjusting bath to a molding apparatus, to produce glass products.

8. A process for producing glass products, which uses the apparatus for producing glass products as defined in claim 6, and comprises melting a glass raw material in a flame of oxygen burner in the glass-melting furnace constituted by the upper furnace body and the lower furnace body to produce a molten glass, storing the molten glass in the furnace-bottom portion of the lower furnace body, and feeding the molten glass stored in the furnace-bottom portion through the temperature-adjusting bath to a molding apparatus, to produce glass products.
